(19) United States
(12) Patent Application Publication
(10) Pub. No.: US 2025/0244068 A1
(43) Pub. Date: Jul. 31, 2025

(54) TROLLEY

(71) Applicant: Haohong Electric Technology (Hubei) Co., Ltd., Huanggang (CN)

(72) Inventor: Min WANG, Huanggang (CN)

(73) Assignee: Haohong Electric Technology (Hubei) Co., Ltd., Huanggang (CN)

(21) Appl. No.: 18/635,221

(22) Filed: Apr. 15, 2024

(30) Foreign Application Priority Data
Jan. 29, 2024 (CN) 202420214657.7

(51) Int. Cl. F25D 3/08; A47B 31/02; B62B 3/00

(52) U.S. Cl. CPC F25D 3/08; A47B 31/02; B62B 3/005; F25D 2303/081

(57) ABSTRACT

A trolley includes a moving bracket and an ice bucket. The moving bracket includes a bracket body, a storage portion and a fixed table, the storage portion and the fixed table are provided on the bracket body, the storage portion is provided below the fixed table and provided with a put-in port, a pick-and-place port is provided between the storage portion and the fixed table, and the put-in port is communicated with the pick-and-place port; and the ice bucket is placed in the storage portion from the put-in port.

### CROSS-REFERENCE TO RELATED APPLICATIONS

The present application claims priority to Chinese Patent Application No. 202420214657.7, filed on Jan. 29, 2024, the entire contents of which are incorporated herein by reference.

### TECHNICAL FIELD

The present application relates to the technical field of catering device, and in particular to a trolley.

### BACKGROUND

In the catering field, trolleys are often used to temporarily process food at a predetermined location. Before processing, the ingredients often need to be kept frozen to ensure the freshness of the ingredients.

The existing trolleys that can freeze and keep food ingredients are usually hollowed out at the bottom of the table to store ice cubes at the bottom of the trolley table.

However, when there are objects or electrical devices on the table, the table plate on the table is blocked by the objects or electrical devices, making it troublesome to open or move the table plate, which makes it inconvenient to access the ice cube and the ingredients on the ice cube.

### SUMMARY

The main purpose of the present application is to provide a trolley, aiming to solve the problem that the existing trolley has a hollowed-out design at the bottom of the table, and the ice cube and food are stored at the bottom of the trolley table, which is very inconvenient to take and place.

To achieve the above purpose, the trolley provided in the present application includes: a moving bracket and an ice bucket.

The moving bracket includes a bracket body, a storage portion and a fixed table, the storage portion and the fixed table are provided on the bracket body, the storage portion is provided below the fixed table and provided with a put-in port, a pick-and-place port is provided between the storage portion and the fixed table, and the put-in port is communicated with the pick-and-place port; and the ice bucket is placed in the storage portion from the put-in port.

In an embodiment, the ice bucket is provided with an accommodating chamber and an opening communicated with the accommodating chamber, the opening is configured to face the fixed table, and a height of the pick-and-place port between the storage portion and the fixed table is greater than a height of the ice bucket.

In an embodiment, the storage portion includes a plurality of fixed members connected to each other and enclosed to form a fixed chamber, and the ice bucket is provided in the fixed chamber.

In an embodiment, the ice bucket includes a first ice bucket and a second ice bucket, the storage portion further includes a separating plate, the separating plate is connected to the fixed member to separate the fixed chamber into a first fixed chamber and a second fixed chamber, the first ice bucket is provided in the first fixed chamber, and the second ice bucket is provided in the second fixed chamber.

In an embodiment, the first ice bucket and the second ice bucket both include a bucket body and two lugs respectively provided on both sides of the bucket body, the two lugs are configured to extend outward and abut against the fixed member and the separating plate, and the accommodating chamber and the opening are provided in the bucket body.

In an embodiment, the first ice bucket and the second ice bucket both include a fixed cover, the bucket body is recessed with a groove, and the fixed cover is configured to cover the accommodating chamber in the groove.

In an embodiment, the fixed table includes a table plate and an extending plate, the table plate is provided on the bracket body and is provided above the storage portion, and the extending plate is provided on one side of the table plate in a width direction and is configured to extend outside.

In an embodiment, the fixed table further includes a storage box provided on one side of the table plate in a length direction.

In an embodiment, the moving bracket further includes a pusher provided on one side of the fixed table away from the extending plate.

In an embodiment, a wheel is provided at a bottom of the moving bracket.

In the present application, the fixed table and the storage portion are provided on the bracket body of the moving bracket. The storage portion is provided below the fixed table, and a pick-and-place port is provided between the storage portion and the fixed table. The ice bucket placed in the storage portion can be taken out from the pick-and-place port. It is convenient to take out the ice bucket. It is also convenient to take out the ice cube or food in the ice bucket from the pick-and-place port. There is no need to open or move the table plate of the fixed table, which is very convenient to operate.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic three-dimensional structural view of a trolley according to an embodiment of the present application.

FIG. 2 is a schematic partially exploded structural view of the trolley according to an embodiment of the present application.

FIG. 3 is a schematic exploded structural view of the trolley according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. among various assemblies under a certain posture as shown in the drawings. If the specific posture changes, the directional indication also changes accordingly.

In the present application, unless otherwise specifically specified and limited, the terms “connected”, “fixed”, etc. should be understood in a broad sense, for example, “fixed” can be a fixed connection, a detachable connection, or be integrated as a whole; “connected” can be a mechanical connection or an electrical connection; can be directly connected, or indirectly connected through an intermediate medium, or can be the internal communication between two elements or the interaction relationship between two elements. For those of skilled in the art, the specific meaning of the above-mentioned terms in the present application can be understood according to specific situations.

In addition, the descriptions of “first”, “second”, etc. are only for the purpose of description, and should not be construed as indicating or implying relative importance or implicitly indicating the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

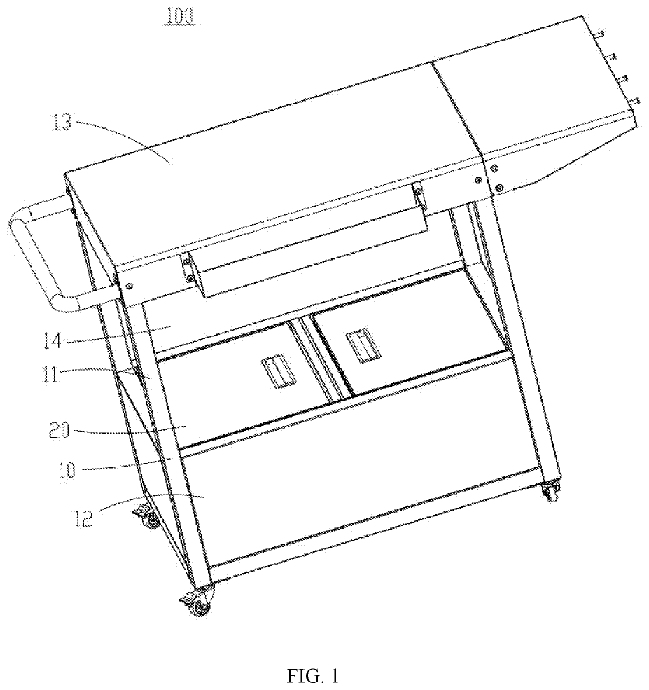

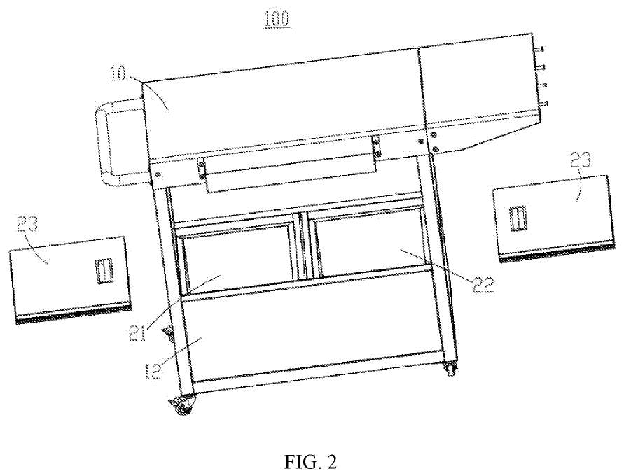

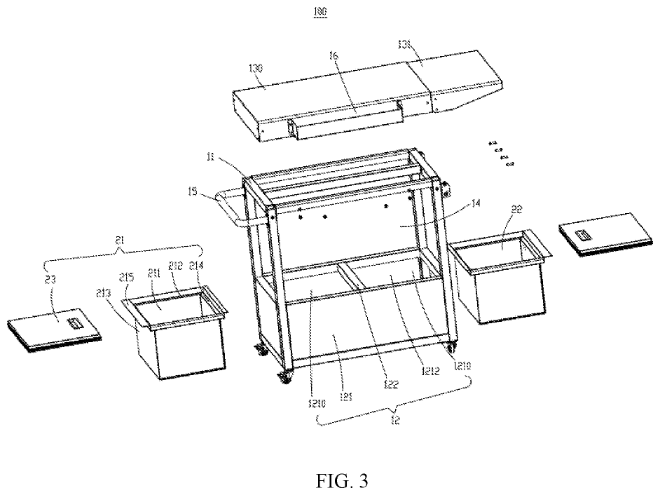

The present application provides a trolley 100. Referring to FIG. 1 to FIG. 3, FIG. 1 is a schematic three-dimensional structural view of a trolley 100 according to an embodiment of the present application. FIG. 2 is a schematic partially exploded structural view of the trolley according to an embodiment of the present application. FIG. 3 is a schematic exploded structural view of the trolley according to an embodiment of the present application.

In an embodiment of the present application, as shown in FIG. 1 to FIG. 3, the trolley 100 provided in the present application includes: a moving bracket 10 and an ice bucket 20.

The moving bracket 10 includes a bracket body 11, a storage portion 12 and a fixed table 13. The storage portion 12 and the fixed table 13 are provided on the bracket body 11. The storage portion 12 is provided below the fixed table 13. The storage portion 12 is provided with a put-in port, and a pick-and-place port 14 is provided between the storage portion 12 and the fixed table 13. The put-in port is communicated with the pick-and-place port 14.

The ice bucket 20 is placed in the storage portion 12 from the put-in port.

Since the storage portion 12 of the existing trolley 100 is provided at the bottom of two movable table plates 130, when taking and placing the ice cube in the storage portion 12, it is necessary to move the two table plates 130 to expose the ice cube in the storage portion 12.

In an embodiment, the storage portion 12 is provided on the bracket body 11 and is provided below the fixed shield. The storage portion 12 is of an open type, and is provided with a put-in port. A pick-and-place port 14 is provided between the storage portion 12 and the fixed table 13, so that the ice bucket 20, the ice cube and food can be put into the storage portion 12 from the pick-and-place port 14 through the put-in port. The ice bucket 20, ice cube and food placed in the storage portion 12 can also be taken out from the pick-and-place port 14 through the put-in port.

The pick-and-place port 14 can be configured as a pick-and-place port 14 structure with three sides closed by limiting plates and only one side open. Alternatively, as shown in FIG. 1 to FIG. 3, the pick-and-place port 14 can be configured as a pick-and-place port 14 structure with only the bracket body 11 on all four sides and open openings on all four sides.

In the present application, the fixed table 13 and the storage portion 12 are provided on the bracket body 11 of the moving bracket 10. The storage portion 12 is provided below the fixed table 13, and a pick-and-place port 14 is provided between the storage portion 12 and the fixed table 13. The ice bucket 20 placed in the storage portion 12 can be taken out from the pick-and-place port 14. It is convenient to pick and place the ice bucket 20, and it is also convenient to take out the ice tube and food in the ice bucket 20 from the pick-and-place port 14 without opening or moving the table plate 130 of the fixed table 13, which is very convenient.

It should be noted that the storage portion 12 can be provided on the bracket body 11 by screws, or can be provided on the bracket body 11 by welding, snapping, plugging, etc. The connection manner between the storage portion 12 and the bracket body 11 is not limited in the present application.

In an embodiment, in order to facilitate placing ice cubes into the storage portion 12 at one time, the trolley 100 is provided with the ice bucket 20 for storing ice cubes. The pick-and-place port 14 between the storage portion 12 and the fixed table 13 is relatively large so that the ice bucket 20 can be taken out from the pick-and-place port 14.

Specifically, in order to take out the ice bucket 20 from the storage portion 12, the ice bucket 20 is provided with an accommodating chamber 211 and an opening 212 communicated with the accommodating chamber 211. The opening 212 faces the fixed table 13, and a height of the pick-and-place port 14 between the storage portion 12 and the fixed table 13 is greater than a height of the ice bucket 20.

In an embodiment, the ice bucket 20 is provided with an accommodating chamber 211 for storing ice cubes and food. The opening 212 of the ice bucket 20 faces the fixed table 13, and the ice bucket 20 is placed into the storage portion 12 from the pick-and-place port 14 through the put-in port. When it is necessary to take out the ice cube and food, the ice cube and food can be taken out directly from the pick-and-place port 14 through the opening 212. Since the height of the pick-and-place port 14 between the storage portion 12 and the fixed table 13 is greater than the height of the ice bucket 20, when the ice bucket 20 needs to be taken out, it can be directly removed from the pick-and-place port 14.

Since ice cubes are stored in the ice bucket 20, water easily drips from the outer wall of the ice bucket 20 due to liquefaction. The ice bucket 20 is placed in the storage portion 12, and the water on the outer wall of the ice bucket 20 drips onto the storage portion 12. The storage portion 12 is easily corroded by water, which reduces the service life of the storage portion 12. For this reason, in an embodiment, the bottom of the storage portion 12 is not closed, and a drain port can be provided at the bottom of the storage portion 12. Water dripping from the outer wall of the ice bucket 20 can be drained to the ground from the drain port, so as to reduce corrosion of water droplets into the storage portion 12.

In an embodiment, the storage portion 12 includes a plurality of fixed members 121 connected to each other and enclosed to form a fixed chamber 1210, and the ice bucket 20 is provided in the fixed chamber 1210.

At least two fixed members 121 are provided to limit the ice bucket 20 in the fixed chamber 1210. In an embodiment, four fixed members 121 are provided, the fixed members 121 are fixed plates, and the plurality of fixed plates are enclosed to form a cubic open fixed chamber 1210.

In an embodiment, the fixed member 121 may also be a long fixed rod. A plurality of fixed rods are enclosed to form the fixed chamber 1210, and the edge of the ice bucket 20 is abutted against the plurality of fixed rods and is provided in the fixed chamber 1210. The ice bucket 20 is abutted against the fixed member 121 to be fixed below the fixed table 13.

In order to accommodate more ice buckets 20, a separating plate 122 can be provided in the storage portion 12. In an embodiment, the ice bucket 20 includes a first ice bucket 21 and a second ice bucket 22. The storage portion 12 also includes a separating plate 122 connected to the fixed member 121, so as to separate the fixed chamber 1210 into a first fixed chamber 1211 and a second fixed chamber 1212. The first ice bucket 21 is provided in the first fixed chamber 1211, and the second ice bucket 22 is provided in the second fixed chamber 1212.

At least one first ice bucket 21 and at least one second ice bucket 22 are provided, and the first ice bucket 21 and the second ice bucket 22 are separated and supported by the separating plate 122. The storage portion 12 is separated into a plurality of first fixed chambers 1211 and a plurality of second fixed chambers 1212 by the separating plate 122, and the plurality of ice buckets 20 can be placed in the storage portion 12.

In order to prevent the first ice bucket 21 and the second ice bucket 22 from falling out of the storage portion 12, both the first ice bucket 21 and the second ice bucket 22 include a bucket body 213 and two lugs 215 respectively provided on both sides of the bucket body 213. The two lugs 215 extend outward and abut against the fixed member 121 and the separating plate 122. The accommodating chamber 211 and the opening 212 are provided in the bucket body 213.

In an embodiment, the first ice bucket 21 and the second ice bucket 22 are both provided with at least two lugs 215 on the edge of the bucket body 213. The two lugs 215 can be abutted against the fixed member 121 and the separating plate 122 respectively, so that the first ice bucket 21 and the second ice bucket 22 are limited and fixed in the storage portion 12. It should be noted that the first ice bucket 21 and the second ice bucket 22 may both be configured as square buckets. The lugs 215 are protrudingly provided on four side portions of the square bucket, and the lug 215 is configured to be abutted against the fixed member 121 and the separating plate 122.

The lugs 215 can be two arc-shaped protrusions, two elongated protrusions, or a circular protruding ring. The structure of the lug 215 is not limited in the present application.

In order to prevent the ice cube in the first ice bucket 21 and the second ice bucket 22 from melting too quickly, both the first ice bucket 21 and the second ice bucket 22 include a fixed cover 23. The bucket body 213 is recessed with a groove 214, and the fixed cover 23 covers the accommodating chamber 211 in the groove 214.

In an embodiment, the first ice bucket 21 and the second ice bucket 22 are both covered with a fixed cover 23. The fixed cover 23 is configured to prevent the ice cubes in each bucket body 213 from being exposed to external high temperatures and melting quickly. The fixed cover 23 can also prevent dust from floating into the bucket body 213 or other debris falling into the bucket body 213.

In order to place more electronic devices or food on the fixed shield, in an embodiment, as shown in FIG. 1 to FIG. 3, the fixed table 13 includes a table plate 130 and an extending plate 131. The table plate 130 is provided on the bracket body 11 and is provided above the storage portion 12. The extending plate 131 is provided on one side of the table plate 130 in a width direction and extends outside.

In an embodiment, the extending plate 131 may be fixed to the bracket body 11 and provided on one side of the table plate 130. The extending plate 131 can be provided on the bracket body 11 by screws, or can be provided on the bracket body 11 by welding, snapping, plugging, etc. In an embodiment, the extending plate 131 is rotatably provided on the bracket body 11 so as to be unfolded or folded relative to the table plate 130. The connection manner between the storage portion 12 and the bracket body 11 is not limited in the present application.

Furthermore, in order to facilitate the storage of various gripping tools or food processing tools, the fixed table 13 also includes a storage box 16 provided on one side of the table plate 130 in a length direction.

In an embodiment, the storage box 16 is detachably provided on the fixed table 13. The storage box 16 can be fixed to the fixed table 13 using screws.

In an embodiment, the storage box 16 is fixedly provided on the fixed table 13. The storage box 16 can be integrally formed with the fixed table 13.

In order to facilitate pushing the trolley 100 to a predetermined position, the moving bracket 10 further includes a pusher 15 provided on the side of the fixed table 13 away from the extending plate 131.

Wheels 17 are provided at a bottom of the moving bracket 10. The user can push the trolley 100 to the predetermined position through the pusher 15.

The above descriptions are only some embodiments of the present application, and are not intended to limit the scope of the present application. Under the inventive concept of the present application, any equivalent structural transformations made by using the contents of the description and drawings of the present application, or direct/indirect applications in other related technical fields, are included in the scope of the present application.

What is claimed is:

1. A trolley, comprising:
a moving bracket comprising a bracket body, a storage portion and a fixed table, wherein the storage portion and the fixed table are provided on the bracket body, the storage portion is provided below the fixed table and provided with a put-in port, a pick-and-place port is provided between the storage portion and the fixed table, and the put-in port is communicated with the pick-and-place port; and
an ice bucket placed in the storage portion from the put-in port.

2. The trolley of claim 1, wherein the ice bucket is provided with an accommodating chamber and an opening communicated with the accommodating chamber, the opening is configured to face the fixed table, and a height of the pick-and-place port between the storage portion and the fixed table is greater than a height of the ice bucket.

3. The trolley of claim 2, wherein the storage portion comprises a plurality of fixed members connected to each other and enclosed to form a fixed chamber, and the ice bucket is provided in the fixed chamber.

4. The trolley of claim 3, wherein the ice bucket comprises a first ice bucket and a second ice bucket, the storage portion further comprises a separating plate, the separating plate is connected to the fixed member to separate the fixed chamber into a first fixed chamber and a second fixed chamber, the first ice bucket is provided in the first fixed chamber, and the second ice bucket is provided in the second fixed chamber.

5. The trolley of claim 3, wherein the first ice bucket and the second ice bucket both comprise a bucket body and two lugs respectively provided on both sides of the bucket body, the two lugs are configured to extend outward and abut against the fixed member and the separating plate, and the accommodating chamber and the opening are provided in the bucket body.

6. The trolley of claim 4, wherein the first ice bucket and the second ice bucket both comprise a fixed cover, the bucket body is recessed with a groove, and the fixed cover is configured to cover the accommodating chamber in the groove.

7. The trolley of claim 1, wherein the fixed table comprises a table plate and an extending plate, the table plate is provided on the bracket body and is provided above the storage portion, and the extending plate is provided on one side of the table plate in a width direction and is configured to extend outside.

8. The trolley of claim 7, wherein the fixed table further comprises a storage box provided on one side of the table plate in a length direction.

9. The trolley of claim 7, wherein the moving bracket further comprises a pusher provided on one side of the fixed table away from the extending plate.

10. The trolley of claim 1, wherein a wheel is provided at a bottom of the moving bracket.
